(19) United States
(12) Patent Application Publication
(10) Pub. No.: US 2024/0006684 A1
(43) Pub. Date: Jan. 4, 2024

(54) BATTERY COOLING SYSTEM

(71) Applicants: Dana Automotive Systems Group, LLC, Maumee, OH (US); Ford Global Technologies, LLC, Dearborn, MI (US)

(72) Inventors: Patrick Daniel MAGUIRE, Ann Arbor, MI (US); Christopher M. COOK, McKenzie, TN (US)

(21) Appl. No.: 17/809,771

(22) Filed: Jun. 29, 2022

(51) Int. Cl. H01M 10/6568; H01M 10/613; H01M 10/625; H01M 10/6554; H01M 10/6556

(52) U.S. Cl. CPC H01M 10/6568; H01M 10/613; H01M 10/625; H01M 10/6554; H01M 10/6556

(57) ABSTRACT

Methods and systems are provided for a battery cooling enclosure. In one embodiment, the battery cooling enclosure may be incorporated in an electric vehicle and may comprise battery cooling system, including a first support rail with a first coolant inlet, a second support rail with a first coolant outlet, and a plurality of cold plate slots arranged in parallel between the first support rail and the second support rail. Each slot of the plurality of cold plate slots is coupled to a first fluid passage of the first support rail and a second fluid passage of the second support rail. The battery cooling system of the battery cooling enclosure may thus allow for cooling of a battery using a variable amount of cold plates.

### TECHNICAL FIELD

The present description relates generally to systems for a cooling enclosure for a battery.

### BACKGROUND AND SUMMARY

A battery assembly, including at least one battery, may be installed in an automotive vehicle for assisting engine start and powering other vehicle systems. The battery assembly may be enclosed in a cover, such as a battery enclosure, to shield the battery assembly from contact with external objects, provide a thermal barrier to inhibit heat conduction from the battery assembly to surrounding components, and maintain the position of the battery assembly relative to the vehicle. The battery enclosure thus provides a barrier between the battery assembly and other objects and reduces a likelihood of combustion arising from overheating or puncture.

In some examples, such as an electric vehicle or a hybrid electric vehicle operating in an all-electric mode, propulsion and operation of other vehicle systems exclusively relies on electric power. The battery may be large to provide sufficient power to meet the vehicle's energy demands. A corresponding battery enclosure may be undesirably heavy, particularly if formed from a conventional material providing durability and rigidity, such as a metal. In order to address this issue, the battery enclosure may instead be formed from a composite material with similar mechanical properties (e.g., durability, tensile strength, etc.).

However, the inventors herein have recognized potential issues with composite battery casings. As one example, the large size of the battery generates heat, however manufacturing of a cold plate of sufficient size to cool the large battery may be challenging due to a desired cold plate size and manufacturing complexity. Because of this, an alternate cooling system is desirable, which may include use of multiple cold plates in parallel or in series.

WO2010/096355 A2 from Louvar et al. discloses a cooling system. The cooling system includes a cold plate subassembly for cooling an electronic component, the subassembly comprising at least two cold plate evaporator devices, each cold plate in direct, thermally conductive contact with an adjacent cold plate effectively forming a single heat transfer plate contacting a single component generating heat, wherein the at least two cold plate evaporator devices are mounted to a single base plate, wherein the at least two cold plate devices are fluidically connected in series. At least one embodiment of the cold plate subassembly comprises an inlet tube to a first cold plate, a transfer tube forming an outlet from a first cold plate and serving as an inlet to an adjacent second cold plate, a third cold plate adjacent the second cold plate and receiving refrigerant from a second transfer tube, and an outlet through which refrigerant exits the cold plate subassembly.

The inventors herein have recognized issues with the examples described above. For example, refrigerant flowing through the at least two cold plates in series may increase in temperature, thus refrigerant flowing through the third cold plate evaporator device may have a higher temperature than refrigerant flowing through the first cold plate evaporator device. Thus, the single component generating heat may be cooled less effectively in a region in contact with the third cold plate evaporator device compared to a region in contact with the first cold plate evaporator device.

In one example, the issues described above may be addressed by a battery cooling system comprising a first support rail with a first coolant inlet, a second support rail with a first coolant outlet, and a plurality of cold plate opening arranged in parallel between the first support rail and the second support rail, wherein each opening of the plurality of cold plate openings is coupled to a first fluid passage of the first support rail and a second fluid passage of the second support rail. In this way, the battery cooling system which accommodates multiple cold plates in parallel may reduce manufacturing complexity while allowing for sufficient cooling of a large battery by flowing coolant through the plurality of cold plates arranged in parallel.

As an example, the first fluid passage of the first support rail may be coupled to a coolant circuit via the first coolant inlet and the second fluid passage of the second support rail may be coupled to the coolant circuit via the first coolant outlet. Each opening of the plurality of cold plate openings, herein referred to as a cold plate slot of a plurality of cold plate slots, may accommodate one cold plate and may further include a second coolant inlet and a second coolant outlet. The second coolant inlet may couple a cold plate slot of the plurality of cold plate slots to the first fluid passage and the second coolant outlet may couple the cold plate slot to the second fluid passage. Coolant may flow into the plurality of cold plate slots via a respective second coolant inlet of each cold plate slot from the first fluid passage. Coolant may enter the cold plates positioned in each of the cold plate slots and thus cool the large battery. Coolant may exit the cold plates through respective cold plate outlets and may flow out of each cold plate slot to the second fluid passage via a respective second coolant outlet. The battery cooling system may further include at least one battery coolant intake port and at least one battery coolant outlet port, which may couple the battery assembly to the coolant circuit such that coolant may circulate through the battery assembly.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example of an electrified vehicle including a battery cooled by a battery cooling system of a battery cooling enclosure.

FIG. 2 shows a perspective view of the battery cooling enclosure.

FIG. 3 shows a detailed view of a support rail of a battery cooling system of the battery cooling enclosure.

FIG. 4 shows a cross-sectional view of the battery cooling enclosure, including a fluid passage of the support rail.

FIG. 5 shows a cross-sectional view of an interface of the fluid passage and a cold plate.

FIG. 6 shows a top-down view of a plurality of cold plate slots of the battery cooling system.

FIG. 7 shows a method for flowing coolant through the battery cooling system.

### DETAILED DESCRIPTION

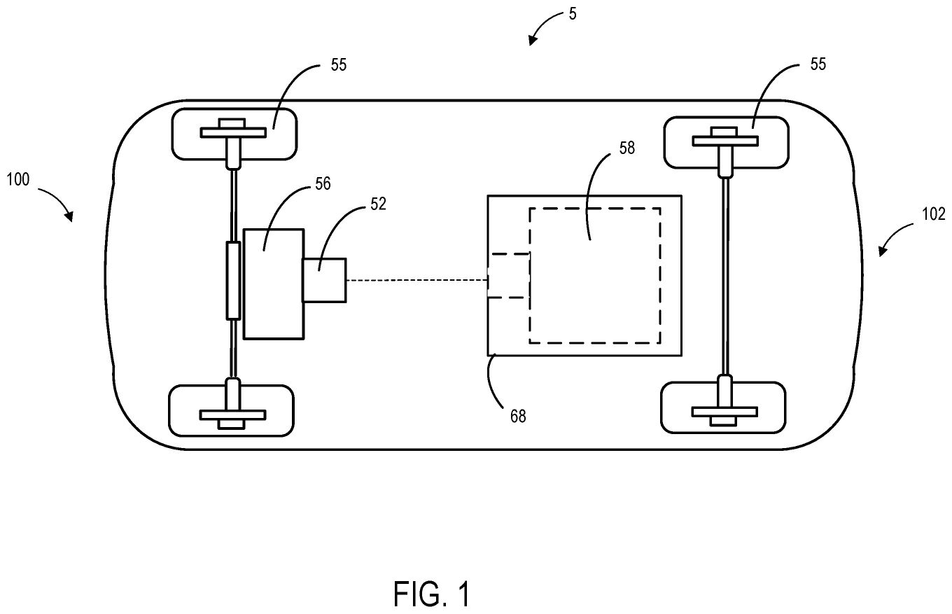

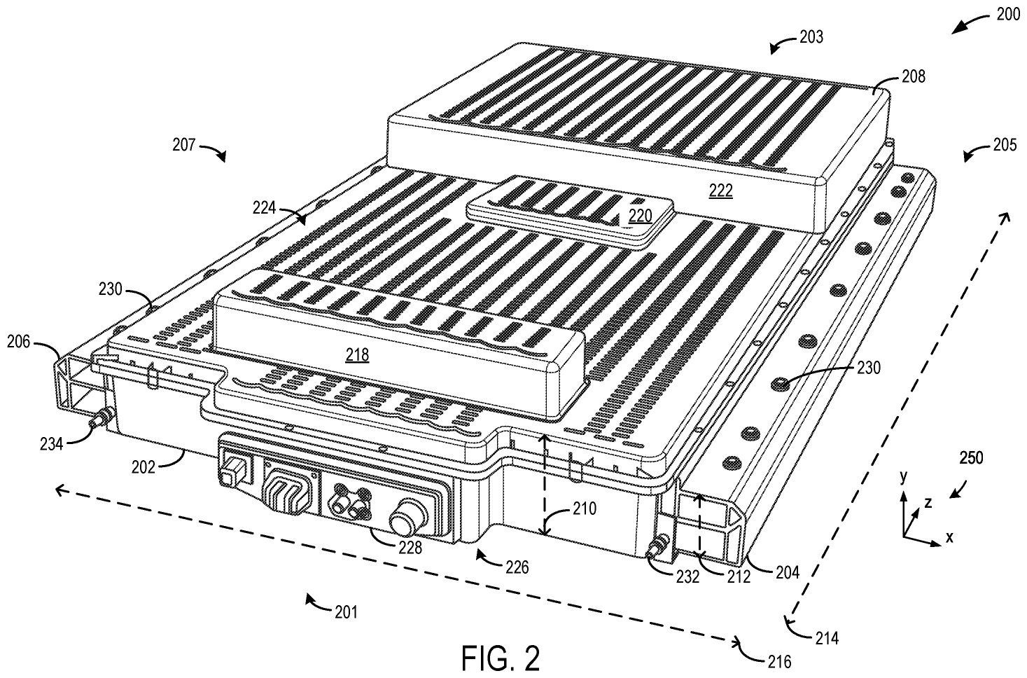

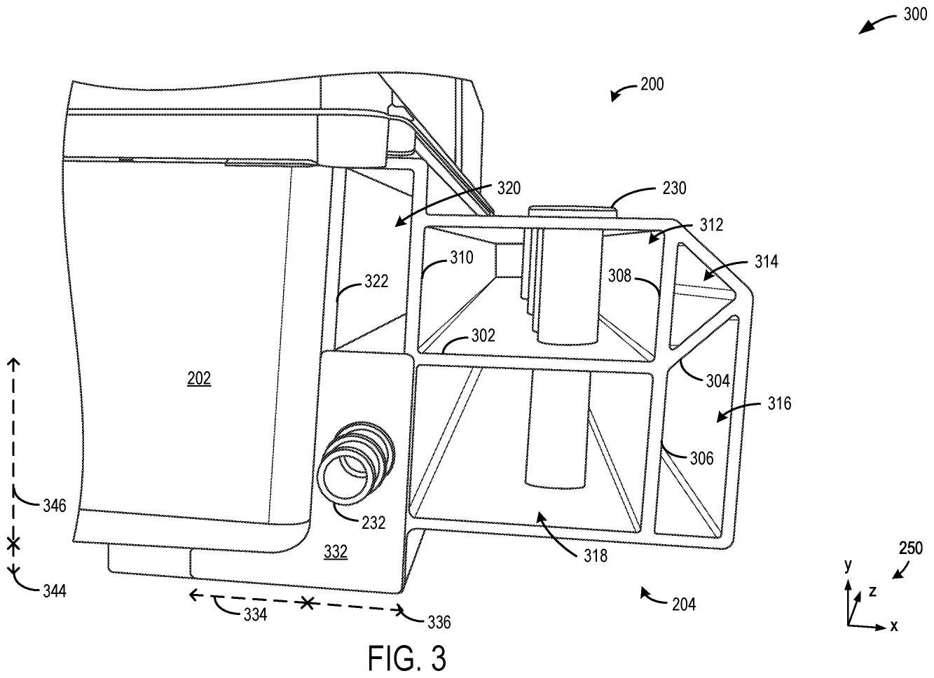

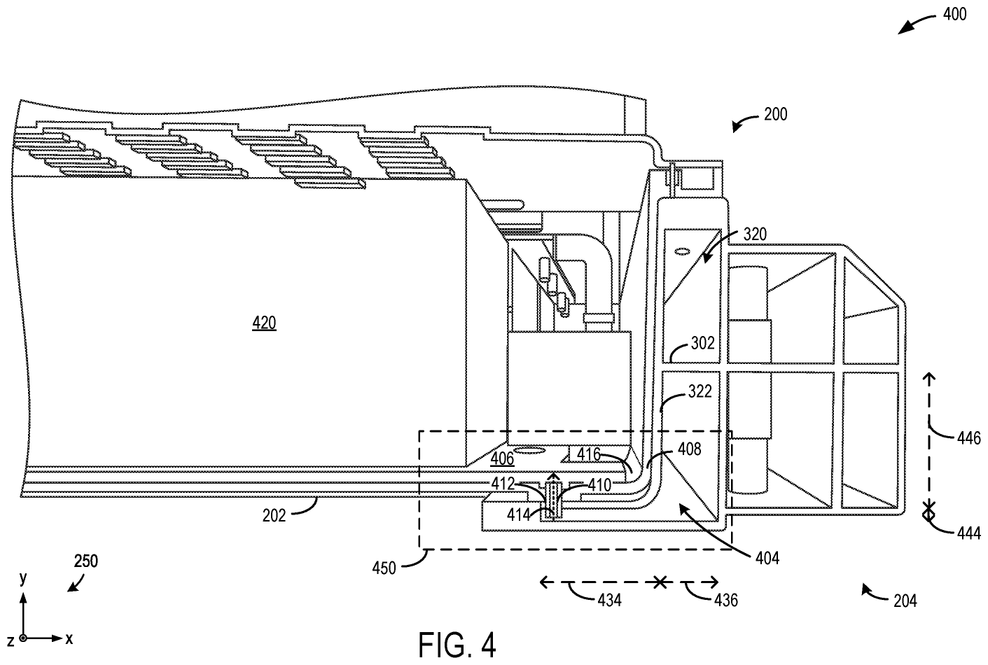

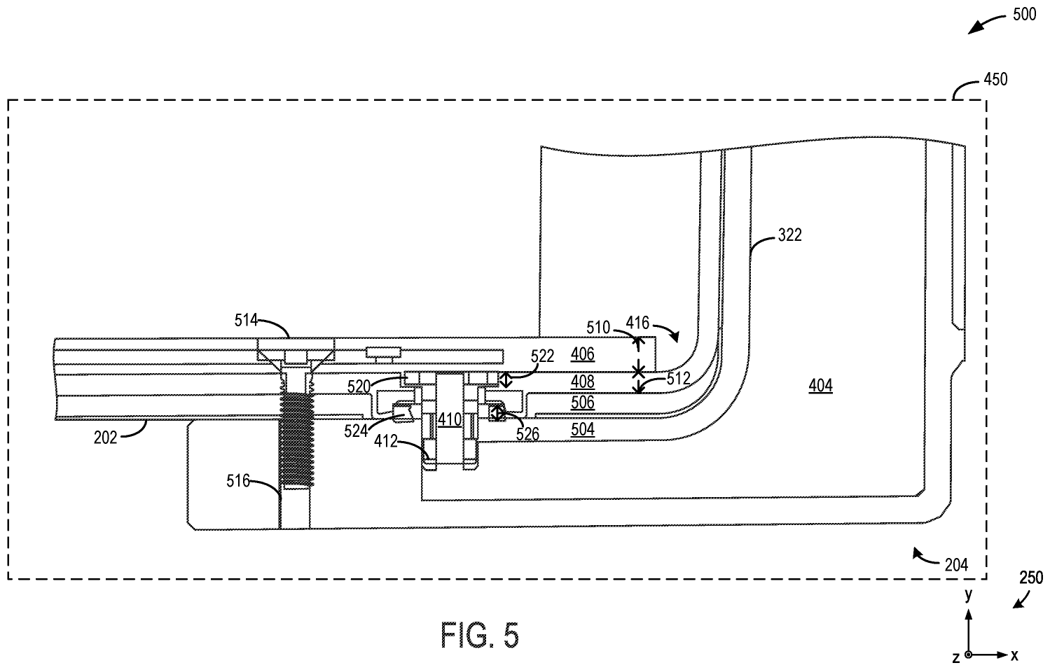

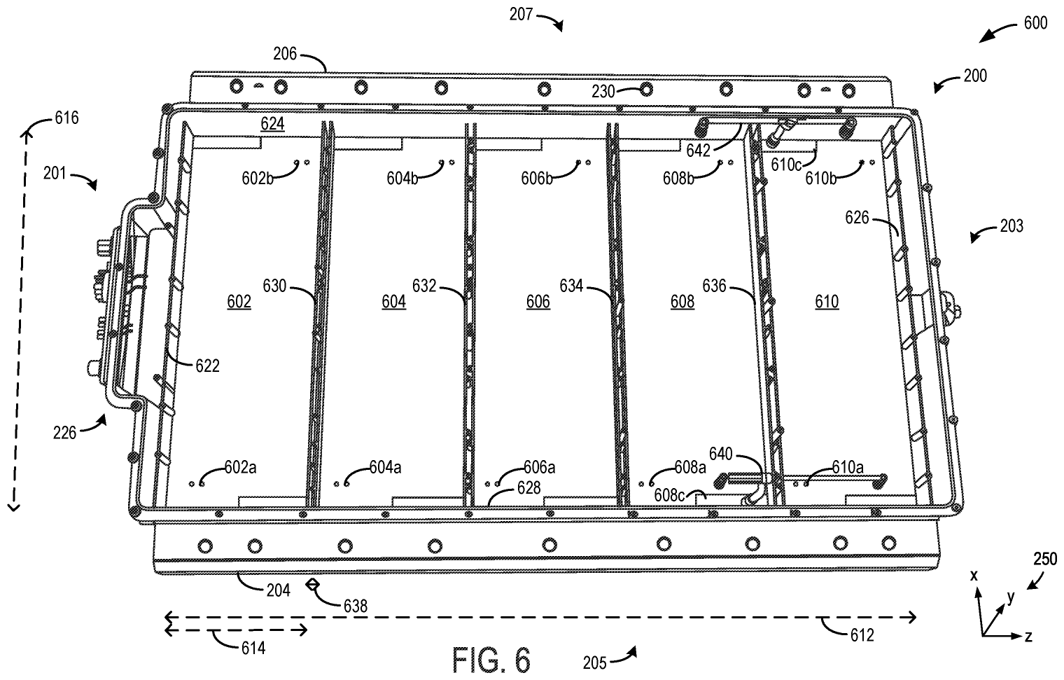

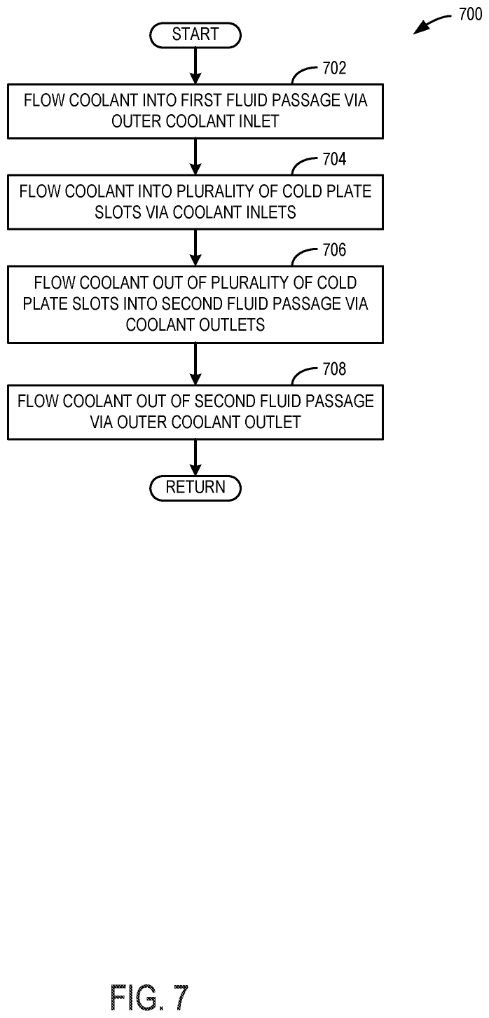

The following description relates to systems and methods for a battery cooling system of a battery cooling enclosure. An example of a vehicle configured with an electrified vehicle drive train system, including a battery housed in the battery cooling enclosure and cooled by a battery cooling system of the battery cooling enclosure, is shown in FIG. 1. FIG. 2 shows a perspective view of the battery cooling enclosure. A detailed view of a support rail of the battery cooling system is shown in FIG. 3, including a coolant inlet to a first fluid passage. FIG. 4 shows a cross-sectional view of the battery cooling enclosure, including the first fluid passage of the battery cooling system. FIG. 5 shows a detailed cross-sectional view of an interface of the first fluid passage and a cold plate. The battery cooling system may include a plurality of cold plates positioned in a plurality of cold plate slots arranged in parallel, as shown in FIG. 6. An example flow of a coolant through the battery cooling system is described in FIG. 7. FIGS. 2-6 are shown approximately to scale.

FIGS. 1-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Turning now to FIG. 1, an example vehicle 5 is shown. In some examples, vehicle 5 may be a hybrid vehicle with multiple sources of torque available to one or more vehicle wheels 55. In other examples, vehicle 5 may be an all-electric vehicle, powered exclusively by an energy storage device such as a battery assembly, herein referred to as a battery 58. In the example shown, vehicle 5 includes an electric machine 52 which may be a motor or a motor/generator. Electric machine 52 receives electrical power from the battery 58 which is converted to rotational energy, e.g., torque, at a transmission 56. The torque is delivered to vehicle wheels 55. Electric machine 52 may also be operated as a generator to provide electrical power to charge battery 58, for example, during a braking operation.

While electric machine 52 is shown providing rotational energy to the vehicle wheels 55 proximate to a front end 100 of vehicle 5, e.g., at front wheels of the vehicle, via the transmission 56, it will be appreciated that the transmission 56 may be alternatively arranged at rear wheels of vehicle 5, e.g., vehicle wheels 55 proximate to a rear end 102 of the vehicle, and energy from the electric machine 52 transmitted thereto. Furthermore, in other examples, each of the front wheels and the rear wheels may be coupled to individual transmissions, such as when vehicle 5 is configured with all-wheel drive.

In the depicted example, the battery 58 may be installed in a rear region of the vehicle, e.g., between the vehicle wheels 55 and closer to the rear end 102 of the vehicle 5 than the front end 100. In one example, the battery 58 may be positioned below rear passenger seats of the vehicle. In other examples, the battery 58 may be located in a floor of a rear compartment of the vehicle or may be integrated into a vehicle chassis. The battery 58 may be secured within a battery enclosure 68 formed of a rigid material, such as a composite, e.g., a polymer composite. The battery enclosure 68 may entirely enclose the battery 58, providing a barrier between the battery 58 and external components, and absorbing vibrations from the vehicle that would otherwise be imparted to the battery 58. In order to install the battery 58 within the battery enclosure 68, the enclosure may be comprised of two parts that are assembled around the battery and secured to one another.

The battery assembly (e.g., the battery 58) may be a single battery or may include a plurality of cells electrically coupled to one another. A quantity of the plurality of cells may determine a capacity of the battery 58. The battery 58 may be configured with a high power-to-weight ratio, high specific energy, and high energy density to provide power over long periods of time. Examples of battery types which may be used in vehicle 5 include lithium-ion, lithium polymer, lead-acid, nickel-cadmium, and nick-metal hydride batteries, amongst others. The battery 58 may be a rechargeable battery, such as a battery formed of lithium-ion cells. When configured as a rechargeable battery, the battery 58 may be recharged by regenerative braking operations or an external power source. Battery performance and life may depend on the applied load (and therefore on the charge/discharge rate), as well as operating conditions (such as temperature). The battery 58 may work efficiently over a range of discharge rates (e.g., C/8-2C), within a target range of operating temperatures (typically from 20° C. to 45° C.), and at relatively uniform temperature (e.g., temperature uniformity of less than 5° C.).

Battery performance and longevity may be affected by temperature, and a range of optimal operating temperatures for battery operation may be narrow. During battery charge/discharge, internal resistances of battery components may drive an increase in battery temperature. In addition, chemical reactions occurring within each of the plurality of cells may be exothermic. For example, a charging operation in nickel-metal hydride batteries may release large quantities of heat, leading to an increased likelihood of thermal runaway. As another example, charging of a lithium ion battery between 10-30° C. may prolong battery life while charging of the battery above 45° C. may lead to swelling of internal components, degradation of plastic components, loss of active chemicals to irreversible reactions, and so on. In other battery types, battery discharge may instead lead to excessive heat generation which may rise as a rate of discharge increases. Furthermore, a demand for robust thermal management may be exacerbated in EV applications, where a traction battery for an EV may be larger than a traction battery for an HEV.

Heat extraction from the battery 58 may be enabled by implementation of a cold plate, which may help maintain the battery temperature within the range of optimal operating temperatures, for example. In other examples, a plurality of cold plates may be incorporated in a battery cooling enclosure or a battery pack to provide cooling to other regions of the battery assembly (e.g., the battery 58). The plurality of cold plates may conduct heat from the battery 58 via direct contact between the plurality of cold plates and bottom faces of each of the plurality of cells of the battery 58. In one example, each cold plate of the plurality of cold plates may be a first type of cold plate, such as a liquid channel cooling plate configured with a fluid passage with a plurality of channels to flow a heat exchange fluid therethrough, thereby providing cooling of the battery 58. As the heat exchange fluid flows through the plurality of channels, heat is transferred to the heat exchange fluid and removed from the cold plate as the heat exchange fluid is cycled between the cold plate and at least one heat exchanger.

In an embodiment shown in FIG. 2, the battery (or plurality of battery cells) may be cooled via a plurality of cold plates arranged in parallel in a battery cooling enclosure 200. The battery cooling enclosure 200 may be an embodiment of the battery enclosure 68 of FIG. 1. A set of reference axes 250 are provided for comparison between views shown in FIG. 2-6. The reference axes 250 indicate a y-axis, an x-axis, and a z-axis. In one example, the y-axis may be parallel with a direction of gravity (e.g., a vertical direction) and the x-z plane may be parallel with a horizontal plane the battery enclosure 68 of FIG. 1 may rest upon. A plane parallel to the y-x plane may be used to create the cross-sections visible in FIGS. 3-5. A plane parallel to the x-z plane may be used to create the cross-section visible in FIG. 6.

The battery cooling enclosure 200 may include a base structure 202, which is configured with a plurality of cold plate openings, herein referred to as a plurality of cold plate slots, not shown in FIG. 2 and further described with respect to FIG. 4 and FIG. 6. The plurality of cold plate slots is positioned in parallel between a first support rail 204 and a second support rail 206. Collectively, the base structure 202, the first support rail 204, the second support rail 206, and elements thereof may be herein referred to as the battery cooling system. Each of the first support rail 204 and the second support rail 206 may include a fluid passage positioned therein, each of which are coupled to each cold plate slot of the plurality of cold plate slots, thus allowing coolant to flow through the plurality of cold plates. A battery, such as the battery 58 of FIG. 1, may be positioned on a top face of the plurality of cold plates and may be enclosed by a cover 208. As briefly described with respect to FIG. 1, the base structure 202 and the cover 208 of the battery cooling enclosure 200 may be formed of a rigid material, such as a composite, e.g., a polymer composite, and may be secured to each other, such as via fasteners, bolts, or other sufficient coupling methods.

The battery cooling enclosure 200 may have a rectangular structure. In other embodiments of the plurality of embodiments, the battery cooling enclosure 200 may have a square structure or other structure designed to be implemented in a vehicle, such as the vehicle 5 of FIG. 1. When the base structure 202 and the cover 208 are coupled, the battery cooling enclosure 200 may have a first height 210. For example, when the battery cooling enclosure 200 has a rectangular structure, the first height 210 may be approximately 173 mm. A second height 212 of each of the first support rail 204 and the second support rail 206 may be less than the first height 210. Additionally, the second height 212 of each of the first support rail 204 and the second support rail 206 may extend below the first height 210 with respect to the y-axis and as further described with reference to FIGS. 3-5. The battery cooling enclosure 200 may further have a first length 214 along the z-axis and a first width 216 along the x-axis. For a rectangular-shaped battery cooling enclosure 200, the first length 214 may be approximately 2074 mm and the first width 216 may be approximately 1300 mm in an embodiment of a plurality of embodiments.

The cover 208 may include a plurality of stepped regions with different heights to accommodate internal components of the battery cooling enclosure 200, such as battery cells, as further described herein. For example, the embodiment shown in FIG. 2 includes a first stepped region 218, a second stepped region 220, and a third stepped region 222. The cover 208 may include a plurality of vent holes 224, which may allow some heat generated by the battery to escape from the battery cooling enclosure 200. Additionally, the cover 208 and the base structure 202 may include an extension 226 on a first face 201 of the battery cooling enclosure 200. The extension may include a plurality of couplings 228 at which the battery enclosed in the battery cooling enclosure 200 may be coupled to an electric machine, such as the electric machine 52 of FIG. 1, to provide and/or receive power.

As briefly described above, the battery cooling system includes the first support rail 204 on a first side 205 of the base structure 202 and the second support rail 206 on a second side 207 of the base structure 202, opposite the first side 205. The first support rail 204 and the second support rail 206 may provide at least one of structural support and resistance against deformation, such as when stress is applied, to the battery cooling enclosure 200. A structure of the first support rail 204 may be a mirrored equivalent of a structure of the second support rail 206 (e.g., mirrored across a y-z plane). Each of the first support rail 204 and the second support rail 206 may have a plurality of support bolts 230 positioned therein to provide further structural support.

The first support rail 204 may have a first coolant inlet 232 (e.g., an outer coolant inlet) at the first face 201 and may be sealed closed at a second face 203, opposite the first face 201. Alternatively, an additional coolant inlet similar or equivalent to the first coolant inlet 232 may be positioned at the second face 203 of the first support rail 204, such that coolant may be delivered to the first support rail 204 from the first face 201 and/or the second face 203. The second support rail 206 may have a first coolant outlet 234 (e.g., an outer coolant outlet) at the first face 201 and may be sealed closed at the second face 203. Alternatively, an additional coolant outlet similar or equivalent to the first coolant outlet 234 may be positioned at the second face 203 of the second support rail 206, such that coolant may flow out of the second support rail 206 from the first face 201 and/or the second face 203. The first coolant inlet 232 and the first coolant outlet 234 may couple the battery cooling enclosure 200 to a cooling system of the vehicle, such as a coolant circuit. For example, the cooling system may include an air conditioning (AC) circuit of the vehicle, which may be used in a heating, ventilation, and air conditioning (HVAC) system of the vehicle to provide cabin heating and cooling. The cooling system may reduce a temperature of coolant prior to entering the battery cooling system of the battery cooling enclosure 200 (and cold plates positioned therein), thereby enabling the coolant to absorb heat from the battery when flowing through cold plates of the battery cooling system.

Turning to FIG. 3, a detailed view 300 of the first support rail 204 of the battery cooling system of the battery cooling enclosure 200 is shown. Elements of the first support rail 204 which are shown in FIG. 2 are equivalently numbered in FIG. 3. As briefly described above, the structure of the first support rail 204 may be a mirrored equivalent of the structure of the second support rail 206 (e.g., mirrored across the y-z plane, with respect to the reference axes 250). The description of the first support rail 204 in FIGS. 3-5 may thus be interpreted as also describing the second support rail 206. Elements of the second support rail 206 which differ from elements of the first support rail 204 will be described herein.

While the base structure 202 and the cover 208 of the battery cooling enclosure 200 may be formed of a composite, the first support rail 204 may be formed of a metal, such as aluminum. Alternatively, the first support rail 204 may be formed of the composite and an interior of the first support rail 204, as further described with respect to FIG. 4, may be lined with a metal (e.g., aluminum). The plurality of support bolts 230 may be positioned along the first length 214 of the first support rail 204 (e.g., along the z-axis) to support a rigidity and resistance to deformation under stress of the first support rail 204. The first support rail 204 may additionally include a plurality of support beams which divide an interior of the first support rail 204 into multiple open-air channels which extend along the first length 214. The multiple open-air channels may not be sealed on the first face 201 and/or the second face 203, as shown in FIG. 2. For example, a first support beam 302, a second support beam 304, a third support beam 306, a fourth support beam 308, a fifth support beam 310, and a sixth support beam 322 may intersect to form a first channel 312, a second channel 314, a third channel 316, a fourth channel 318, and a fifth channel 320. Alternate embodiments of the first support rail 204 may include a greater or lesser number of support beams to form greater than or less than five open-air channels.

The first support rail 204 further includes a first fluid passage positioned behind a cover 332 including the first coolant inlet 232. The cover 332 may have a third height 346 for a second width 336 and a fourth height 344 for a third width 334. In this way, the cover 332 surrounds a corner of the base structure 202 of the battery cooling system and seals the first fluid passage from the environment. As further described with respect to FIGS. 4-6, the first fluid passage may extend the first length 214 of the first support rail 204 and may contain coolant therein.

As described above, the second support rail 206 (not shown in FIG. 3) may have a similar structure to the structure of the first support rail 204, as described with respect to FIG. 3. The second support rail 206 may similarly include a plurality of support beams which divide an interior of the second support rail 206 into multiple open-air channels which extend along the first length 214. Additionally, the second support rail 206 includes a second fluid passage positioned behind a cover, which may be equivalent to the cover 332 and include the first coolant outlet 234 instead of the first coolant inlet 232. As further described with respect to FIGS. 4-6, the second fluid passage may extend the first length 214 of the second support rail 206 and may contain coolant therein.

FIG. 4 shows a cross-sectional view 400 of a portion of the battery cooling system of the battery cooling enclosure 200, including a detailed view of a coupling of the first fluid passage to a cold plate slot. The cross-sectional view 400 is shown with the cross-sectional cut along the y-x plane, with respect to the reference axes 250. The cross-sectional view 400 may include elements of FIGS. 2-3 which are equivalently numbered.

As shown in FIG. 4, the first support rail 204 includes a first fluid passage 404 therein. The first support beam 302 may extend behind the cover 332 (not shown in FIG. 4) along the x-axis to separate the first fluid passage 404 from the fifth channel 320. Additionally, the sixth support beam 322 may extend behind the cover 332 in the negative y-direction, with respect to the reference axes 250, to separate the first fluid passage 404 of the first support rail 204 from a battery tray 408, as further described below. The first fluid passage 404 may have a fifth height 446 for a fourth width 436 and a sixth height 444 for a fifth width 434. The fifth height 446, the fourth width 436, the sixth height 444, and the fifth width 434 may be less than the third height 346, the second width 336, the fourth height 344, and the third width 334, respectively, as described with respect to FIG. 3. Thus the cover 332 may seal coolant within the first fluid passage 404 and allow coolant to flow into the first fluid passage 404 via the first coolant inlet 232 (not shown in FIG. 4). In one of a plurality of embodiments, the first fluid passage 404 may be formed of an extruded aluminum profile within the first support rail 204. The first fluid passage 404 may extend along the first length 214 of the first support rail 204, as shown in FIGS. 2 and 6.

The first fluid passage 404 may be at least partially filled with coolant during vehicle operation (e.g., the vehicle 5 of FIG. 1). Alternatively, the first fluid passage 404 may be at least partially filled with coolant both during vehicle operation and when the vehicle is not operational when a coolant reservoir (e.g., of the cooling system coupled to the battery cooling system of the battery cooling enclosure 200) has at least a minimum volume of coolant therein. The minimum volume of coolant may be determined by a manufacturer of the cooling system and/or coolant reservoir, and may be an amount of coolant used to sufficiently cool elements which the cooling system is coupled to, such as the AC circuit, the HVAC system, and so on. Coolant flow is further described with respect to FIGS. 5-7.

As described above, the second support rail 206 (not shown in FIG. 4) may have a similar structure to the structure of the first support rail 204, as described with respect to FIG. 4. The second support rail 206 includes the second fluid passage which may have equivalent, mirrored dimensions (e.g., length, width, and height) as the first fluid passage 404. The second fluid passage may be at least partially filled with coolant, which has flowed out of the plurality of cold plates, during vehicle operation. Coolant flow through the second fluid passage is further described with respect to FIGS. 5-7.

Returning to FIG. 4, the first fluid passage 404 may be coupled to each slot of a plurality of cold plate slots via a plurality of inlets, as further described in FIG. 6. As described above, each cold plate slot of the plurality of cold plate slots may be configured as an opening in which a cold plate may be positioned. For example, the cold plate slot may be a rectangular recess, pocket, or receiving chamber in which the cold plate may be positioned. Coupling of the first fluid passage 404 to a first slot of the plurality of cold plate slots is shown in a region denoted by a dashed line box 450, which is shown in further detail in FIG. 5. Briefly, with respect to FIG. 4, the first fluid passage 404 is fluidically coupled to a first cold plate 406 positioned in a first cold plate slot 416 of the battery tray 408, wherein the battery tray 408 includes a plurality of cold plate slots arranged in parallel, as further described with respect to FIG. 6. The battery tray 408 may make up a bottom of each cold plate slot, as well as external walls of the plurality of cold plate slots, as further described with respect to FIG. 6. Coolant may flow from the first fluid passage 404 into the first cold plate 406 via a channel 410 within a first environmental grommet 412 in a direction shown by a dashed arrow 414, as further described with respect to FIG. 5. The channel 410 may herein be referred to as a second coolant inlet. In this way, a battery 420, which may be the battery 58 of FIG. 1 and/or a battery cell of a plurality of cells, may be cooled by the first cold plate 406 and the plurality of cold plates positioned in the plurality of cold plate slots.

The second fluid passage of the second support rail (not shown in FIG. 4) may similarly be coupled to each slot of the plurality of cold plate slots via a plurality of outlets, as further described in FIG. 6. The second fluid passage may be coupled to the first cold plate 406 positioned in the first cold plate slot 416 of the battery tray 408 via a second coolant outlet (e.g., a channel within a second environmental grommet), such that coolant may flow out of the first cold plate 406 into the second fluid passage. Further description of coolant flow is described with respect to FIGS. 5-7.

In a further embodiment, the first fluid passage and the second fluid passage may be positioned in the same support rail. For example, the cover 332 of the first support rail 204, as described with respect to FIG. 3, may be configured with the first coolant inlet 232 and the first coolant outlet 234, which may be vertically stacked along the third height 346. The first fluid passage 404, as described with respect to FIG. 4, may be divided into the first fluid passage 404 and the second fluid passage, such that the first fluid passage 404 and the second fluid passage are fluidically separate. The first fluid passage 404 and the second fluid passage may be vertically stacked, where the first fluid passage 404 may be positioned above the second fluid passage with respect to the fifth height 446, in some of a plurality of embodiments. The first fluid passage 404 may be coupled to the coolant circuit via the first coolant inlet 232, as described herein, and second fluid passage may be similarly coupled to the coolant circuit via the first coolant outlet 234. The second fluid passage may be coupled to the plurality of cold plate slots similarly to how the first fluid passage 404 is coupled to the plurality of cold plate slots, as described herein. Thus, in some of the plurality of embodiments, the first fluid passage 404 and the second fluid passage may be positioned in one of the same support rail or in different support rails (e.g., the first support rail 204 and/or the second support rail 206).

Turning now to FIG. 5, the region denoted by the dashed line box 450 in FIG. 4 is shown in a detailed view 500. The detailed view 500 may include elements of FIGS. 2-4 which are equivalently numbered. FIG. 5 shows the interface between the first fluid passage 404 and the first cold plate 406. An interface between the second fluid passage and the first cold plate 406 may be similar to the interface shown in FIG. 5, as further described, but not shown, herein.

The first fluid passage 404 may contain a volume of coolant therein, where the coolant is deposited into the first fluid passage 404 from a coolant reservoir via the first coolant intake (not shown) as described above. The first fluid passage 404 may be formed of metal, such as aluminum, which may line an interior of the first fluid passage 404 (e.g., where the volume of coolant is held). In the embodiment shown in FIG. 5, an aluminum bar 504 may be coupled to or may be included in the sixth support beam 322 to provides structural support for the first fluid passage 404. The sixth support beam 322 may be formed of aluminum both when other support beams of the first support rail 204 (e.g., the first support beam 302, the second support beam 304, the third support beam 306, the fourth support beam 308, and the fifth support beam 310) are formed of metal or formed of composite.

A heat shield 506 may be positioned on a top face of the aluminum bar 504 and may insulate the aluminum bar 504 and coolant in the first fluid passage 404 from heat generated by the battery (not shown) and/or absorbed by the plurality of cold plates, such as the first cold plate 406. The battery tray 408 may be positioned on a top face of the heat shield 506 and may be configured with the plurality of cold plate slots, each of which may be sized to have one cold plate positioned therein. The plurality of cold plates, wherein one cold plate is positioned in each cold plate slot (in the embodiment disclosed herein) may be sized such that the cold plate (e.g., the first cold plate 406) extends a seventh height 510 above an eighth height 512 of a cold plate slot. The battery (e.g., the plurality of battery cells) may rest on the top face of the cold plates. Further details regarding configuration of the battery tray 408 and positioning of cold plates therein are described with respect to FIG. 6.

The first support rail 204 may be coupled to the base structure 202 via a bolt 514. The bolt 514 may be threaded through a slot 516 which extends through the base structure 202 and the first support rail 204. In other embodiments, the first support rail 204 may be coupled to the base structure 202 via a weld, fixed bolt, or other sufficient coupling device.

As described with respect to FIG. 4, the first fluid passage 404 may be coupled to the first cold plate 406 positioned in the first cold plate slot 416 of the battery tray 408. When the battery tray 408 is configured with a plurality of cold plate slots in parallel, as further described with respect to FIG. 6, each cold plate slot of the plurality of cold plate slots may be similarly coupled to the first fluid passage 404 as described herein with respect to coupling of the first cold plate 406 to the first fluid passage 404. Each cold plate slot of the plurality of cold plate slots may include a second coolant inlet (e.g., the channel 410) which may couple the cold plate positioned on the respective cold plate slot to the first fluid passage 404, as described herein.

The first environmental grommet 412 may include a first seal 520 which circumferentially surrounds the channel 410 for a ninth height 522. When a cold plate, such as the first cold plate 406, is positioned in a cold plate slot of the battery tray 408, an inlet of the cold plate may be vertically aligned with the channel 410 (e.g., the second coolant inlet). The first environmental grommet 412 may fluidically couple the inlet of the cold plate to the first fluid passage 404 via the channel 410, and the first seal 520 may seal the first environmental grommet 412 to the inlet of the cold plate, such that coolant may flow through the channel 410 into the first cold plate 406 without leaking into a space between the battery tray 408 and the first cold plate 406. In other words, the first seal 520 may prevent coolant from flowing out of the channel 410 and pooling in the cold plate slot of the battery tray 408 in which the first cold plate 406 is positioned instead of flowing into the first cold plate 406.

A second seal 524 may circumferentially surround the first environmental grommet 412 below (e.g., with respect to the y-axis) the first seal 520. The second seal 524 may have a tenth height 526 which may be greater than, less than, or equal to the ninth height 522 of the first seal 520. The second seal 524 may be positioned in the battery tray 408 and may rest on a top face of the aluminum bar 504. In this way, the second seal 524 may be an external coolant seal which seals the first fluid passage 404 from the battery tray 408. In other words, the second seal 524 may restrict coolant from traveling along an exterior of the first environmental grommet 412 (e.g., instead of and/or in addition to through the channel 410) and pooling in the cold plate slot of the battery tray 408.

A second fluid flow passage may be similarly coupled to the first cold plate 406 positioned in the first cold plate slot 416 of the battery tray 408. When the battery tray 408 is configured with a plurality of cold plate slots in parallel, as further described with respect to FIG. 6, each cold plate slot of the plurality of cold plate slots may be similarly coupled to the second fluid passage as described herein with respect to coupling of the first cold plate 406 to the second fluid passage. Each cold plate slot of the plurality of cold plate slots may include a second coolant outlet which may couple the cold plate positioned on the respective cold plate slot to the second fluid passage, as described herein.

The second support rail (not shown in FIG. 5) may similarly include a second environmental grommet with a channel therein, which may couple the first cold plate 406 to the second fluid passage, such that coolant may flow from the first cold plate 406 into the second fluid passage, as further described with respect to FIG. 6. The second environmental grommet may further include a third seal and a fourth seal which are similarly configured to the first seal 520 and the second seal 524, respectively of the first environmental grommet 412.

Turning to FIG. 6, a top view 600 of a plurality of cold plate slots of the battery cooling system of the battery cooling enclosure 200 is shown. The top view 600 may be a view of the battery cooling system (e.g., the battery cooling enclosure 200 with the cover 208 removed) and without cold plates positioned in the plurality of cold plate slots. The embodiment of the battery cooling system shown in FIG. 6 includes a battery tray (e.g., the battery tray 408 of FIGS. 4-5) having a first cold plate slot 602 (e.g., the first cold plate slot 416 of FIG. 4), a second cold plate slot 604, a third cold plate slot 606, a fourth cold plate slot 608, and a fifth cold plate slot 610. Thus, the battery tray may form a bottom of each cold plate slot (e.g., a face of each cold plate slot which rests on the heat shield 506, as described with respect to FIG. 5). The battery tray may also form external walls of the plurality of cold plate slots, including a first external wall 622 along a sixth width 616 of the first face 201, a second external wall 624 along a third length 612 of the second side 207, a third external wall 626 along the sixth width 616 of the second face 203, and a fourth external wall 628 along the third length 612 of the first side 205. In this way, each cold plate slot of the plurality of cold plate slots is separated from the first fluid passage and the second fluid passage by the battery tray and support beams of the first support rail 204 and the second support rail 206. In other embodiments, the battery cooling system may include greater than or less than five cold plate slots arranged in parallel. The first cold plate slot 602, the second cold plate slot 604, the third cold plate slot 606, the fourth cold plate slot 608, and the fifth cold plate slot 610 may be collectively referred to herein as the plurality of cold plate slots. In some embodiments, the battery cooling system may include one cold plate slot which may accommodate a single cold plate. The single cold plate may be configured with multiple inlets and multiple outlets which may couple the single cold plate to the first fluid passage 404 and to the second fluid passage, respectively, as further described herein.

Each cold plate slot of the plurality of cold plate slots may be similarly configured in terms of height, width, and length. For example, each cold plate slot may have the eighth height 512, as described with respect to FIG. 5, the sixth width 616, and a fourth length 614. The sixth width 616 and the fourth length 614 may be less than the first width 216 and the first length 214, respectively. In this way, each cold plate slot of the plurality of cold plate slots may be configured to have the same type of cold plate positioned therein. In the embodiment disclosed herein, the battery cooling system may be configured such that each cold plate slot may have a single cold plate positioned therein.

As described with respect to FIGS. 4-5, each cold plate slot of the plurality of cold plate slots may be coupled to the first fluid passage (not shown in FIG. 6) via the second coolant inlet (e.g., the channel 410 of the first environmental grommet 412), wherein each cold plate slot is configured with a coolant inlet equivalent to the channel 410. For example, the first cold plate slot 602 has a third coolant inlet 602a, the second cold plate slot 604 has a fourth coolant inlet 604a, the third cold plate slot 606 has a fifth coolant inlet 606a, the fourth cold plate slot 608 has a sixth coolant inlet 608a, and the fifth cold plate slot 610 has a seventh coolant inlet 610a. Each of the third coolant inlet 602a, the fourth coolant inlet 604a, the fifth coolant inlet 606a, the sixth coolant inlet 608a, and the seventh coolant inlet 610a may be collectively referred to as the second coolant inlet. When a cold plate is positioned in a cold plate slot of the plurality of cold plate slots, the inlet of the cold plate may be vertically aligned with the second coolant inlet (e.g., the channel 410 of the first environmental grommet 412) of the respective cold plate slot. The first seal (e.g., the first seal 520) may seal the first environmental grommet to the inlet of the cold plate, such that coolant may flow through the channel 410 into the cold plate without leaking into the space between the battery tray (e.g., the respective cold plate slot) and the cold plate, as described with respect to FIG. 5.

Each cold plate slot of the plurality of cold plate slots may additionally be coupled to the second fluid passage (not shown in FIG. 6) positioned in the second support rail 206, via the second coolant outlet (e.g., the channel within the second environmental grommet). Each cold plate slot is configured with a coolant outlet equivalent to the second coolant outlet. For example, the first cold plate slot 602 has a third coolant outlet 602b, the second cold plate slot 604 has a fourth coolant outlet 604b, the third cold plate slot 606 has a fifth coolant outlet 606b, the fourth cold plate slot 608 has a sixth coolant outlet 608b, and the fifth cold plate slot 610 has a seventh coolant outlet 610b. Each of the third coolant outlet 602b, the fourth coolant outlet 604b, the fifth coolant outlet 606b, the sixth coolant outlet 608b, and the seventh coolant outlet 610b may be collectively referred to as the second coolant outlet. When a cold plate is positioned in a cold plate slot of the plurality of cold plate slots, an outlet of the cold plate may be vertically aligned with the second coolant outlet (e.g., the channel of the second environmental grommet) of the respective cold plate slot. The first seal (e.g., the first seal 520) may seal the first environmental grommet to the inlet of the cold plate, such that coolant may flow through the channel 410 into the cold plate without leaking into the space between the battery tray (e.g., the respective cold plate slot) and the cold plate, as described with respect to FIG. 5.

As shown in FIG. 6, the plurality of cold plate slots, and therefore the plurality of cold plates positioned therein, are arranged in parallel, with respect to a direction of coolant flow through the plurality of cold plates. For example, a first wall may 630 separate the first cold plate slot 602 and the second cold plate slot 604, a second wall 632 may separate the second cold plate slot 604 and the third cold plate slot 606, a third wall 634 may separate the third cold plate slot 606 and the fourth cold plate slot 608, and a fourth wall 636 may separate the fourth cold plate slot 608 and the fifth cold plate slot 610. Each of the first wall 630, the second wall 632, the third wall 634, and the fourth wall 636 may extend the sixth width 616 of the plurality of cold plate slots, may have the eighth height 512, and may have a seventh length 638.

In some embodiments, the battery cooling system may be configured with a single cold plate slot within which a single cold plate may be positioned. For example, the single cold plate slot may extend the third length 612 and the sixth width 616 and may include multiple coolant inlets and multiple coolant outlets, which may be positioned as shown in FIG. 6. In other words, the single cold plate slot may be configured as the plurality of cold plate slots (e.g., the first cold plate slot 602, the second cold plate slot 604, the third cold plate slot 606, the fourth cold plate slot 608, and the fifth cold plate slot 610) with the walls therebetween removed (e.g., the first wall 630, the second wall 632, the third wall 634, and the fourth wall 636). The single cold plate positioned therein may have a plurality of coolant inlets and coolant outlets which align and coupled with coolant inlets and coolant outlets of the single cold plate slot. For example, the single cold plate slot may include at least one of the third coolant inlet 602a, the fourth coolant inlet 604a, the fifth coolant inlet 606a, the sixth coolant inlet 608a, and the seventh coolant inlet 610a, and may further include at least one of the third coolant outlet 602b, the fourth coolant outlet 604b, the fifth coolant outlet 606b, the sixth coolant outlet 608b, and the seventh coolant outlet 610b. A number of coolant inlets and a number of coolant outlets of the single cold plate may equal a number of coolant inlets and a number of coolant outlets of the single cold plate slot, respectively.

Coolant may flow in parallel through each cold plate of the plurality of cold plates, which are arranged in parallel. For example, coolant may flow from the cooling system of the vehicle (e.g., the vehicle 5 of FIG. 1) into the first fluid passage in the first support rail 204 via the first coolant inlet (not shown in FIG. 6) on at least one of the first face 201 and/or the second face 203 of the battery cooling enclosure 200. Coolant may enter each cold plate slot of the plurality of cold plate slots, and therefore the cold plate positioned therein, from the first fluid passage via the second coolant inlet of each cold plate slot (e.g., the third coolant inlet 602a, the fourth coolant inlet 604a, the fifth coolant inlet 606a, the sixth coolant inlet 608a, and the seventh coolant inlet 610a). Coolant may flow through each of the cold plates independently (e.g., through channels of each respective cold plate) and absorb heat generated by the battery positioned on the top face of the plurality of cold plates (not shown in FIG. 6, as described with respect to FIG. 4). Coolant may flow out of each of the plurality of cold plates into the second fluid passage via the second coolant outlet of each cold plate slot (e.g., the third coolant outlet 602b, the fourth coolant outlet 604b, the fifth coolant outlet 606b, the sixth coolant outlet 608b, and the seventh coolant outlet 610b). Coolant may flow out of the second fluid passage (in the second support rail 206) into the cooling system of the vehicle via the first coolant outlet (not shown in FIG. 6) on at least one of the first face 201 and/or the second face 203 of the battery cooling enclosure 200. In this way, each of the cold plates positioned in each slot of the plurality of cold plate slots may be independently provided with coolant and thus absorb heat from the battery and/or battery cells which are generating heat. Coolant flow through the battery cooling system of the battery cooling enclosure 200 is further described with respect to FIG. 7.

Additionally, the battery cooling system of the battery cooling enclosure 200 may include a first coupling 640 and a second coupling 642 which directly couple the battery assembly (e.g., battery 58 of FIG. 1) to the coolant circuit, such that coolant may circulate through the battery assembly. The first coupling 640 may include at least one battery coolant intake port and the second coupling 642 may include at least one battery coolant outlet port. On a bottom side of the battery assembly (not shown in FIG. 6), where the battery assembly is in face sharing contact with the plurality of cold plates, coolant may be delivered to the battery assembly from the coolant circuit via the first coupling 640 and coolant may be returned to the coolant circuit from the battery assembly via the second coupling 642. Coupling of the first coupling 640 and the second coupling 642 to the battery assembly may be completed using hoses fit to battery coolant ports (e.g., of the battery assembly) via hose clamps, quick connects, or other suitable means. The first coupling 640 and the second coupling 642 may be coupled to elements of the cooling circuit such as coolant pumps, heat exchangers, and/or other components to support flow and inlet temperature of the coolant to the battery.

The first coupling 640 may vertically extend from a region 608c of the fourth cold plate slot 608 on which a cold plate positioned therein may not rest. The first coupling 640 may vertically extend a height greater than the height of the cold plate (e.g., greater than a sum of the seventh height 510 and the eighth height 512). Above the height of the cold plate, the first coupling 640 may extend horizontally (e.g., along the z-axis) and may include a first battery coolant intake port and a second first battery coolant intake port, via which coolant is delivered from the coolant circuit to the battery assembly. The second coupling 642 may couple the coolant circuit to the battery assembly at the fifth cold plate slot 610. The second coupling 642 may vertically extend from a region 610c of the fifth cold plate slot 610 on which a cold plate positioned therein may not rest. The second coupling 642 may vertically extend a height equal to the height of the first coupling 640 (e.g., greater than the height of the cold plate). Above the height of the cold plate, the second coupling 642 may extend horizontally (e.g., along the z-axis) and may include a first battery coolant outlet port and a second battery coolant outlet port, via which coolant may flow from the battery assembly into the coolant circuit.

Turning to FIG. 7, a method 700 is described for flowing coolant through the battery cooling system of the battery cooling enclosure 200. The method 700 may describe a flow of coolant through the battery cooling system of the battery cooling enclosure 200 with respect to FIGS. 2-6, and it should be understood that similar methods may be used with other systems without departing from the scope of this disclosure. The battery cooling enclosure 200 may be fluidically coupled to the vehicle's AC circuit, which may circulate through an HVAC system, as described above. The battery cooling enclosure 200 may include a battery and/or a plurality of battery cells therein (e.g., the battery 58 of FIG. 1), and the battery cooling enclosure 200 may be positioned in the vehicle such that the battery cooling enclosure 200, and therefore the battery and the plurality of cold plates positioned in the plurality of cold plate slots, are oriented in a horizontal position with cells of the battery positioned on top of an upper surface of the plurality of cold plates.

At 702, the method 700 includes flowing coolant into a first fluid passage via an outer coolant outlet. For example, coolant may flow into the first fluid passage (e.g., the first fluid passage 404 in the first support rail 204) from a coolant reservoir, a radiator, or other cooling system element which provides coolant which is at a temperature that allows heat generated by the battery to be absorbed by the coolant. The outer coolant outlet (e.g., the first coolant outlet 234) may be positioned on at least one of the first face and/or the second face of the battery cooling enclosure 200, thus coolant may flow into the first fluid passage from at least one of the first face and/or the second face.

At 704, the method 700 includes flowing coolant into the plurality of cold plate slots via coolant inlets. The plurality of cold plate slots may be arranged in parallel and may each have a second coolant inlet which couples the respective cold plate slot to the first fluid passage. Each cold plate slot of the plurality of cold plate slots may have a cold plate positioned therein such that the inlet of the cold plate is in vertical alignment with the second coolant inlet of the respective cold plate, and coolant may flow into the cold plate. Coolant may flow in parallel through each cold plate positioned in each of the plurality of cold plate slots. A battery assembly containing a battery and/or a plurality of battery cells may be positioned on top of (e.g., in face sharing contact with) the plurality of cold plates positioned in the plurality of cold plate slots. The battery (and/or plurality of battery cells) may generate heat when providing power to the vehicle (e.g., to propel the vehicle and/or provide power to auxiliary components of the vehicle). Coolant flowing through the cold plates may absorb heat from the battery, thus cooling the battery and/or allowing the battery to have a desired operating temperature. Coolant flowing through the cold plates is thus heated as the coolant flows in a net direction from the first fluid passage to the second fluid passage.

At 706, the method 700 includes flowing coolant out of the plurality of cold plate slots and into the second fluid passage via coolant outlets. Coolant which may have absorbed heat from the battery may flow out of a respective cold plate via the cold plate outlet in vertical alignment with the second coolant outlet of the respective cold plate slot. Thus, coolant from the plurality of cold plate slots may flow into the second fluid passage.

At 708, the method 700 includes flowing coolant out of the second fluid passage via the outer coolant outlet. Similarly to the first fluid passage, the second fluid passage may have an outer coolant outlet positioned on at least one of the first face and/or the second face of the battery cooling enclosure 200, thus coolant may flow out of the second fluid passage from at least one of the first face and/or the second face.

In this way, heat generated by a battery and/or battery cells may be absorbed by a plurality of cold plates arranged in parallel, such that the battery and/or battery cells may operate at a desired operating temperature. Arranging a plurality of cold plate slots, and therefore the plurality of cold plates in parallel, where each cold plate is independently coupled to a first fluid passage for receiving coolant and a second fluid passage for returning heated coolant to a cooling system, may allow for adaptation of the battery cooling enclosure for different sized batteries. For example, more cold plates may be added in parallel to cool larger batteries and less cold plates may be used to cool smaller batteries. Additionally, a plurality of cold plates may be used to cool a large battery instead of using a single, large cold plate to cool the large battery. Further, arranging the plurality of cold plates in parallel and thus flowing coolant through the plurality of cold plates in parallel may allow each of the plurality of cold plates to absorb a similar or substantially equal amount of heat from the battery, thus the battery may be evenly cooled along the length and width of the battery (e.g., which is in face sharing contact with the plurality of cold plates).

The disclosure also provides support for a battery cooling system for an electric vehicle, comprising: a first support rail with a first coolant inlet, a second support rail with a first coolant outlet, and a plurality of cold plate openings arranged in parallel between the first support rail and the second support rail, wherein each opening of the plurality of cold plate openings is coupled to a first fluid passage of the first support rail and a second fluid passage of the second support rail. In a first example of the system, the first support rail is positioned along a first length of the plurality of cold plate openings and the second support rail is positioned along a second length of the plurality of cold plate openings, opposite the first length. In a second example of the system, optionally including the first example, each of the first fluid passage and the second fluid passage is positioned inside an extruded aluminum profile of the first support rail and the second support rail, respectively. In a third example of the system, optionally including one or both of the first and second examples, each of the first fluid passage and the second fluid passage are sealed on a first end and a second end, opposite the first end. In a fourth example of the system, optionally including one or more or each of the first through third examples, the first end of the first fluid passage is sealed by the first coolant inlet and the first end of the second fluid passage is sealed by the first coolant outlet. In a fifth example of the system, optionally including one or more or each of the first through fourth examples, the battery cooling system is fluidically coupled to an electric vehicle system via the first coolant inlet and the first coolant outlet. In a sixth example of the system, optionally including one or more or each of the first through fifth examples, each opening of the plurality of cold plate openings accommodates one cold plate. In a seventh example of the system, optionally including one or more or each of the first through sixth examples, each opening of the plurality of cold plate openings comprises a coolant inlet and a coolant outlet. In an eighth example of the system, optionally including one or more or each of the first through seventh examples, a second coolant inlet of a cold plate opening of the plurality of cold plate openings couples the cold plate opening to the first fluid passage. In a ninth example of the system, optionally including one or more or each of the first through eighth examples, a second coolant outlet of the cold plate opening couples the cold plate opening to the second fluid passage. In a tenth example of the system, optionally including one or more or each of the first through ninth examples, the system further comprises: a battery assembly including at least one battery cell positioned on a top face of cold plates arranged in the plurality of cold plate openings. In an eleventh example of the system, optionally including one or more or each of the first through tenth examples, the system further comprises: at least one battery coolant intake port and at least one battery coolant outlet port, wherein each of the at least one battery coolant intake port and the at least one battery coolant outlet port couples the battery assembly to a coolant circuit such that coolant flows into the battery assembly from the coolant circuit via the at least one battery coolant intake port and coolant flow out of the battery assembly to the coolant circuit via the at least one battery coolant outlet port.

The disclosure also provides support for a method for cooling an electric vehicle battery, comprising: flowing coolant into a first fluid passage of a battery cooling enclosure via an outer coolant inlet, flowing coolant from the first fluid passage into a plurality of inner cold plate slots arranged in parallel, wherein each slot accommodates one cold plate and each slot comprises one coolant inlet and one coolant outlet, flowing coolant out of the plurality of inner cold plate slots into a second fluid passage, and flowing coolant out of the battery cooling enclosure via an outer coolant outlet. In a first example of the method, a coolant inlet of a cold plate slot of the plurality of inner cold plate slots couples the cold plate slot to the first fluid passage, such that coolant flows from the first fluid passage into the cold plate slot via the coolant inlet. In a second example of the method, optionally including the first example, a coolant outlet of the cold plate slot couples the cold plate slot to the second fluid passage, such that coolant flows from the cold plate slot to the second fluid passage via the coolant outlet. In a third example of the method, optionally including one or both of the first and second examples, the first fluid passage is positioned in a first interior of a first support rail and the second fluid passage is positioned in a second interior of a second support rail, wherein the plurality of inner cold plate slots are positioned between the first support rail and the second support rail. In a fourth example of the method, optionally including one or more or each of the first through third examples, coolant flows into the first fluid passage from a coolant reservoir of a vehicle cooling system via the outer coolant inlet. In a fifth example of the method, optionally including one or more or each of the first through fourth examples, coolant flows out of the second fluid passage to a radiator of the vehicle cooling system.

The disclosure also provides support for an electric vehicle, comprising: at least one electric machine coupled to at least one battery, the at least one battery positioned in a battery cooling enclosure, wherein the battery cooling enclosure is configured with at least one outer coolant inlet, at least one outer coolant outlet, and a plurality of inner cold plate slots arranged in parallel, each slot accommodating one cold plate, each slot comprising one coolant inlet and one coolant outlet. In a first example of the system, the at least one outer coolant inlet couples a first fluid passage to a coolant circuit of the electric vehicle and the at least one outer coolant outlet couples a second fluid passage to the coolant circuit, wherein the first fluid passage and the second fluid passage are positioned in one of the same support rail or in different support rails, and each slot of the plurality of inner cold plate slots is coupled to the first fluid passage via a coolant inlet and coupled to the second fluid passage via a coolant outlet.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery cooling system for an electric vehicle, comprising:
a first support rail with a first coolant inlet;
a second support rail with a first coolant outlet; and
a plurality of cold plate openings arranged in parallel between the first support rail and the second support rail, wherein each opening of the plurality of cold plate openings is coupled to a first fluid passage of the first support rail and a second fluid passage of the second support rail.

2. The battery cooling system of claim 1, wherein the first support rail is positioned along a first length of the plurality of cold plate openings and the second support rail is positioned along a second length of the plurality of cold plate openings, opposite the first length.

3. The battery cooling system of claim 1, wherein each of the first fluid passage and the second fluid passage is positioned inside an extruded aluminum profile of the first support rail and the second support rail, respectively.

4. The battery cooling system of claim 1, wherein each of the first fluid passage and the second fluid passage are sealed on a first end and a second end, opposite the first end.

5. The battery cooling system of claim 4, wherein the first end of the first fluid passage is sealed by the first coolant inlet and the first end of the second fluid passage is sealed by the first coolant outlet.

6. The battery cooling system of claim 1, wherein the battery cooling system is fluidically coupled to an electric vehicle system via the first coolant inlet and the first coolant outlet.

7. The battery cooling system of claim 1, wherein each opening of the plurality of cold plate openings accommodates one cold plate.

8. The battery cooling system of claim 7, wherein each opening of the plurality of cold plate openings comprises a coolant inlet and a coolant outlet.

9. The battery cooling system of claim 8, wherein a second coolant inlet of a cold plate opening of the plurality of cold plate openings couples the cold plate opening to the first fluid passage.

10. The battery cooling system of claim 9, wherein a second coolant outlet of the cold plate opening couples the cold plate opening to the second fluid passage.

11. The battery cooling system of claim 1, further comprising a battery assembly including at least one battery cell positioned on a top face of cold plates arranged in the plurality of cold plate openings.

12. The battery cooling system of claim 11, further comprising at least one battery coolant intake port and at least one battery coolant outlet port, wherein each of the at least one battery coolant intake port and the at least one battery coolant outlet port couples the battery assembly to a coolant circuit such that coolant flows into the battery assembly from the coolant circuit via the at least one battery coolant intake port and coolant flow out of the battery assembly to the coolant circuit via the at least one battery coolant outlet port.

13. A method for cooling an electric vehicle battery, comprising:
flowing coolant into a first fluid passage of a battery cooling enclosure via an outer coolant inlet;
flowing coolant from the first fluid passage into a plurality of inner cold plate slots arranged in parallel, wherein each slot accommodates one cold plate and each slot comprises one coolant inlet and one coolant outlet;
flowing coolant out of the plurality of inner cold plate slots into a second fluid passage; and
flowing coolant out of the battery cooling enclosure via an outer coolant outlet.

14. The method of claim 13, wherein a coolant inlet of a cold plate slot of the plurality of inner cold plate slots couples the cold plate slot to the first fluid passage, such that coolant flows from the first fluid passage into the cold plate slot via the coolant inlet.

15. The method of claim 14, wherein a coolant outlet of the cold plate slot couples the cold plate slot to the second fluid passage, such that coolant flows from the cold plate slot to the second fluid passage via the coolant outlet.

16. The method of claim 13, wherein the first fluid passage is positioned in a first interior of a first support rail and the second fluid passage is positioned in a second interior of a second support rail, wherein the plurality of inner cold plate slots are positioned between the first support rail and the second support rail.

17. The method of claim 13, wherein coolant flows into the first fluid passage from a coolant reservoir of a vehicle cooling system via the outer coolant inlet.

18. The method of claim 17, wherein coolant flows out of the second fluid passage to a radiator of the vehicle cooling system.

19. An electric vehicle, comprising:
at least one electric machine coupled to at least one battery, the at least one battery positioned in a battery cooling enclosure, wherein the battery cooling enclosure is configured with at least one outer coolant inlet, at least one outer coolant outlet, and a plurality of inner cold plate slots arranged in parallel, each slot accommodating one cold plate, each slot comprising one coolant inlet and one coolant outlet.

20. The electric vehicle of claim 19, wherein the at least one outer coolant inlet couples a first fluid passage to a coolant circuit of the electric vehicle and the at least one outer coolant outlet couples a second fluid passage to the coolant circuit, wherein the first fluid passage and the second fluid passage are positioned in one of the same support rail or in different support rails, and each slot of the plurality of inner cold plate slots is coupled to the first fluid passage via a coolant inlet and coupled to the second fluid passage via a coolant outlet.
